(19) United States
(12) Patent Application Publication
(10) Pub. No.: US 2017/0320536 A1
(43) Pub. Date: Nov. 9, 2017

(54) BRAKE FOR BICYCLE

(71) Applicant: Yuan-Hung WEN, Chang Hua County (TW)

(72) Inventor: Yuan-Hung WEN, Chang Hua County (TW)

(21) Appl. No.: 15/465,068

(22) Filed: Mar. 21, 2017

(30) Foreign Application Priority Data
May 6, 2016 (TW) 105114113

(51) Int. Cl. B62L 1/12

(52) U.S. Cl. CPC B62L 1/12

(57) ABSTRACT

A brake for a bicycle includes a base, a first arm assembly and a second arm assembly. The base is for being unmovably fixed to a frame of the bicycle. The first atm assembly is pivoted to the base and has a first end portion, a second end portion and an actuating portion, the first end portion is for connection of a brake cable, and the second end portion is for clamping one brake surface of a wheel. The second arm assembly is pivoted to the base and has a third end portion, a fourth end portion and an actuated portion, the actuated portion interferes with the actuating portion on a pivoting direction thereof, and the fourth end portion is for s clamping another brake surfaces of the wheel.

### BACKGROUND OF THE INVENTION

### Field of the Invention

The present invention relates to a brake for a bicycle.

### Description of the Prior Art

In a conventional brake for a bicycle, a brake cable pulls a first aim assembly to approach one of two brake surfaces first and then drives a second arm assembly to move to the other of the two brake surfaces. With this type of structure, there is a time difference between the functioning time of the brakes on the left-hand side and right-hand sides which may cause braking deviation or too much pressure on single one arm assembly. Therefore, as disclosed in TWM505444, a brake which can brake synchronously is provided.

In this type of brake, a seat has an adjustable screw, a brake cable has to be disposed through the adjustable screw before being connected to the first arm assembly, and a tightness of the adjustable screw influences the braking efficacy.

However, person who is not skilled in the art cannot precisely and quickly adjust the screw to an appropriate position; in other words, there is an extra uncertainty in the braking operation which may have unfavorable influence to the braking and assembling processes. In addition, the base has to be additionally provided with a pulling arm for positioning the adjustable screw, so an overall weight and a volume occupied increase. Furthermore, the pulling arm which extends outwardly may hook on surrounding objects easily and cause unexpected accidents.

The present invention has arisen to mitigate and/or obviate the afore-described disadvantages.

### SUMMARY OF THE INVENTION

The major object of the present invention is to provide a brake for a bicycle, which further streamlines a weight and a structure of the brake for the bicycle and provide the function of braking synchronously so that the brake for the bicycle can be quickly assembled, and there may be more uncertain factors which influence adjustment of the brake.

To achieve the above and other objects, a brake for a bicycle is provided, for being assembled to a bicycle, the bicycle having a plurality of holding members, each said holding member being for a brake cable being movably disposed therethrough. The brake for the bicycle includes a base, a first arm assembly and a second arm assembly. The base is for being unmovably fixed to a frame of the bicycle. The first arm assembly is pivoted to the base and has a first end portion, a second end portion and an actuating portion, the first end portion is for connection of the brake cable which is disposed through the holding member, and the second end portion is for swinging toward and clamping one of two brake surfaces of a wheel. The second arm assembly is pivoted to the base and has a third end portion, a fourth end portion and an actuated portion, the actuated portion interferes with the actuating portion on a pivoting direction thereof, and the fourth end portion is for swinging toward and clamping the other of the two brake surfaces of the wheel.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a preferred embodiment of the present invention;

FIG. 2 is a breakdown view of the preferred embodiment of the present invention;

FIG. 3 is a cross-sectional view of an actuated portion of the preferred embodiment of the present invention; and

FIGS. 4 and 5 are drawings showing the preferred embodiment of the present invention in operation.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

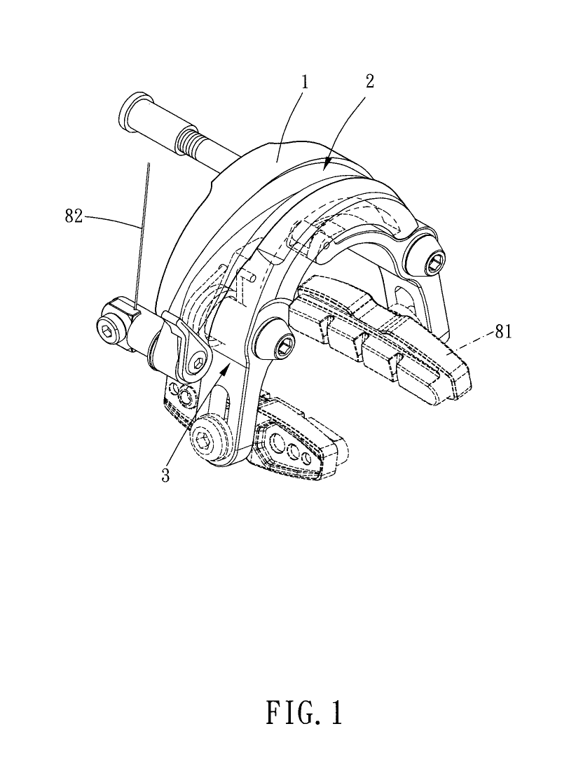

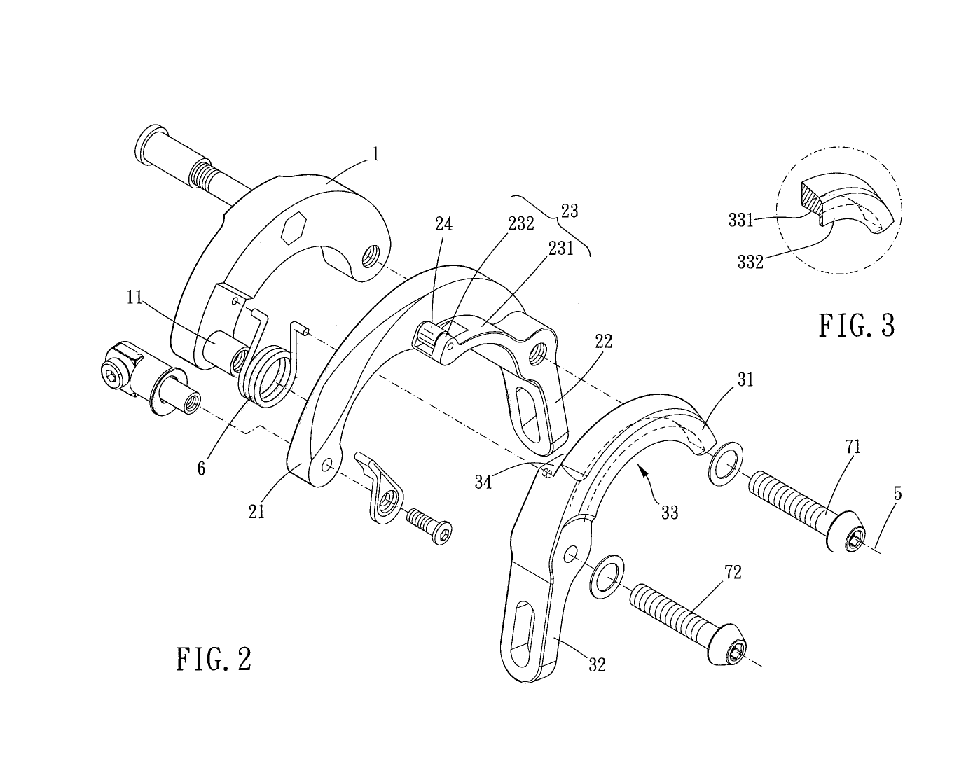

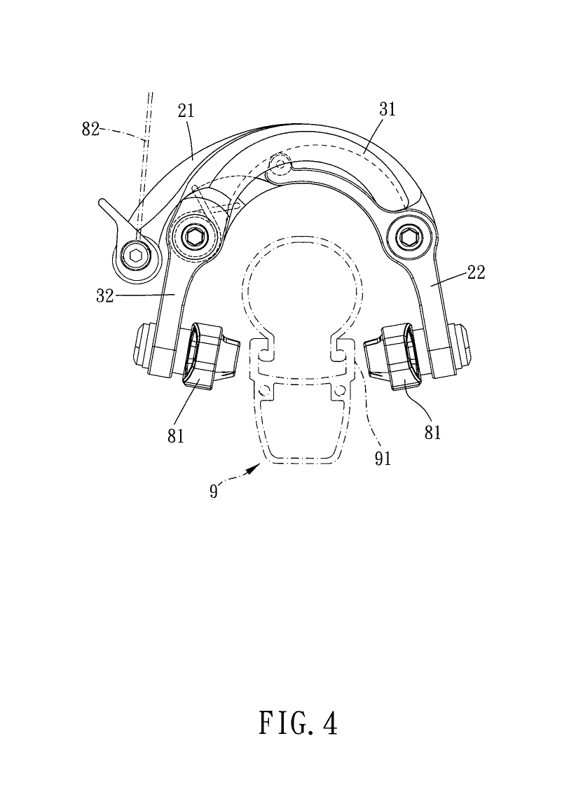

Please refer to FIGS. 1 to 5 for a preferred embodiment of the present invention. A brake for a bicycle is provided for being assembled to a bicycle, the bicycle has a plurality of holding members (for example, a guiding tube or a positioning tube), each said holding member is for a brake cable 82 being movably disposed therethrough, and the brake for the bicycle includes a base 1, a first arm assembly 2 and a second arm assembly 3.

The base 1 is for being unmovably fixed to a frame of the bicycle. The first arm assembly 2 is pivoted to the base 1 and has a first end portion 2, a second end portion 22 and an actuating portion 23, the first end portion 21 is for connection of the brake cable 82 which is disposed through the holding member, and the second end portion 22 is for swinging toward and clamping one of two brake surfaces 91 of a wheel 9. The second aim assembly 3 is pivoted to the base 1 and has a third end portion 31, a fourth end portion 32 and an actuated portion 33, the actuated portion 33 interferes with the actuating portion 23 on a pivoting direction thereof, and the fourth end portion 32 is for swinging toward and clamping the other of the two brake surfaces 91 of the wheel 9. In this embodiment, the actuated portion 33 interferably arranged above the actuating portion 23 on the pivoting direction thereof, the actuating portion and/or the actuated portion may be a linkage mechanism or other structure, and the actuated portion may be actuated, by the actuated portion, from bottom side or any other lateral side thereof as long as the actuating portion and the actuated portion move in response to each other.

The second end portion 22 and the fourth end portion 32 further respectively have a braking member 81, and each said braking member 81 is for contacting each of the two brake surfaces 91 so as to stop the wheel 9 from rotating.

It is understandable that a user can change the braking member 81 with different braking effects according to different requirements so as to provide a suitable braking effect.

To be more specific on the brake for the bicycle of the present invention, the first and second arm assemblies 2, 3 are pivoted to the base 1 along a first direction 5, the first end portion 21 is located between the base 1 and the third end portion 31, and the actuating portion 23 and the actuated portion 33 overlap with each other and crossly arranged. More specifically, as viewed in the first direction 5, the base 1 is c-shaped, the first and second arm assemblies 2, 3 are respectively assembled on two sides of the base 1, and on the first direction 5, the actuating portion 23 and the actuated portion 33 are substantially in a same dimension.

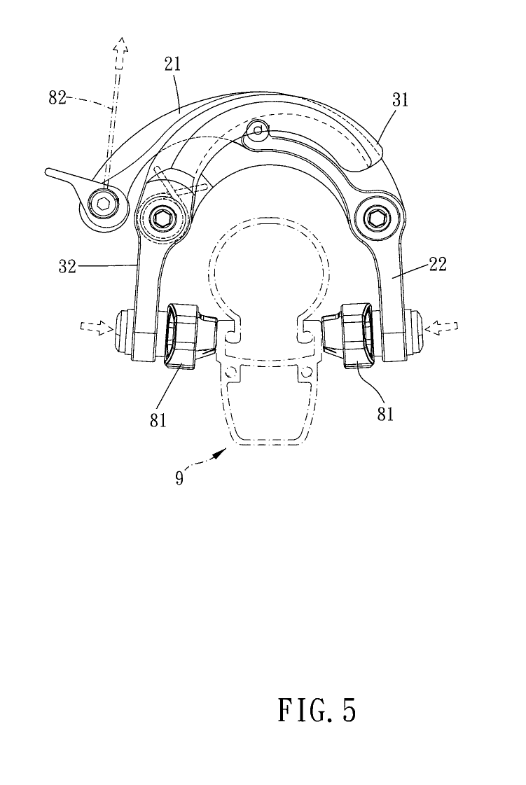

To be more specific on a braking operation (please refer to FIGS. 4 and 5), since the brake cable 82 is disposed through the holding member to be directly connected to the first end portion 21 without being connected to or passing other objects, so when during the braking operation, the brake cable 82 can quickly and directly transfer forces to immediately brake. When the first end portion 21 is pulled, the second end portion 22 swings toward and clamp one of the two brake surfaces 91 and simultaneously drives the actuating portion 23 to push the actuated portion 33 and further force the fourth end portion 32 to swings toward and clamp the other of the two brake surfaces 91 to brake synchronously. Preferably, the first arm assembly 2 and the second arm assembly 3 are respectively integrally formed so that the first arm assembly 2 and the second arm assembly 3 have more complete and solid structures to endure expected impacts and are easier to be assembled.

Preferably, the actuating portion 23 has a rolling member 24 which rotatably abuts against the actuated portion 33, during the process of the actuating portion 23 abuts against the actuated portion 33, a friction is effectively decreased, and the actuating portion 23 and the actuated portion 33 can move synchronously more smoothly. Specifically, the actuated portion 33 includes a guiding section 331 and a cover portion 332, the rolling member 24 rotatably abuts against the guiding section 331, and the cover portion 332 is arranged on the guiding section 331 and covers at least one part of the rolling member 24 so as to ensure that the rolling member 24 will not be blocked by foreign objects from outside and stuck during a rolling process. In this embodiment, the cover portion 332 perpendicularly extends above the guiding section 331, and the guiding section 331 is curved to cooperate with the rolling member 24 to move more smoothly. More specifically, the actuating portion 23 includes a base 231 and a rolling seat 232, the base 231 extends from the first end portion 21 along the first direction 5, the rolling seat 232 is arranged on a distal end of the base 231 and protrudes laterally beyond the base 231, and the rolling member 24 is rotatably arranged on the rolling seat 232. The base 231 does not contact the guiding section 331 so as to make sure there is no unexpected interference. It is to be noted that the base 231 is curved, and the base 231 is greater than the guiding section 331 in curvature radius; therefore, during the braking process, when the first and second arm assemblies 2, 3 swing to a particular angle, at least one of the rolling member 24 and the rolling member 232 abuts against the guiding section 331 to prevent the actuating portion 23 from being disengaged with the actuated portion 33 and cannot recover to a state before braking.

In addition, preferably, the second arm assembly 3 further has blocking portion 34, and the blocking portion 34 optionally abuts against the first end portion 21. In this embodiment, the blocking portion 34 extends from the fourth end portion 32 and is located between the fourth end portion 32 and the base 1, and the first end portion 21 extends across the blocking portion 34. When the second end portion 22 and the fourth end portion 32 move away from each other to a particular angle, the first end portion 21 abuts against the blocking portion 34 to restrict the second end portion 22 and the fourth end portion 32 from swinging away from the wheel 9.

It is to be noted that the brake for the bicycle preferably further includes an elastic member 6, two ends of the elastic member 6 respectively abut against the base 1 and the second arm assembly 3 so that the second end portion 22 and the fourth end portion 32 have a tendency to move away from the brake surface 91. Once a braking action ends, the elastic member 6 can make the second and fourth end portions 22, 32 to move away from the wheel 9 automatically to prevent each said braking member 81 from contacting each of the two brake surfaces 91 continuously.

Specifically, in this embodiment, the elastic member 6 is a twisting spring, the first arm assembly is pivoted to the base 1 via a first pivot shaft 71, the second arm assembly 3 is pivoted to the base 1 via a second pivot shaft 72, and the second pivot shaft 72 is disposed through the elastic member 6. When braking, the first arm assembly 2 co-moves the second arm assembly 3 to twist and compress the elastic member 6, so during the braking and swinging process, the second arm assembly 2 is not easily influenced by a bouncing resistance of the elastic member 6.

More specifically, the base 1 has a spacing portion 11, the second arm assembly 3 abuts against the spacing portion 11, the elastic member 6 is disposed around the spacing portion 11, the second pivot shaft 72 is disposed through the second aim assembly 3 and the spacing portion 11, and the second arm assembly 3 swings, about the second pivot shaft 72, relative to the spacing portion 11. During an assembling process, the spacing portion 11 can quickly and easily position the elastic member 6 and the second arm assembly 3 on designed positions so as to make sure that the fourth end portion and the second end portion 22 are symmetrical to each other to provide a preferable braking effect.

Given the above, in the brake of the bicycle, the brake cable is directly connected to the first end portion without passing other components, so a braking reaction time can be reduced. In addition, with the linkage design, the first and second arm assemblies can swing toward and clamp the wheel synchronously without time difference so as to provide a preferable braking effect, and the braking process will not influenced by the bouncing resistance of the elastic member. Besides, the first and second arm assemblies are set with fixed swinging ranges to prevent the first and second arm assemblies from swinging overly.

While we have shown and described various embodiments in accordance with the present invention, it should be clear to those skilled in the art that further embodiments may be made without departing from the scope of the present invention.

What is claimed is:

1. A brake for a bicycle, for being assembled to a bicycle, the bicycle having a plurality of holding members, each said holding member being for a brake cable being movably disposed therethrough, the brake for the bicycle including:
a base, for being unmovably fixed to a frame of the bicycle;
a first arm assembly, pivoted to the base, having a first end portion, a second end portion and an actuating portion, the first end portion for connection of the brake cable which is disposed through the holding member, the second end portion for swinging toward and clamping one of two brake surfaces of a wheel;
a second arm assembly, pivoted to the base, having a third end portion, a fourth end portion and an actuated portion, the actuated portion interfering with the actuating portion on a pivoting direction thereof, the fourth end portion for swinging toward and clamping the other of the two brake surfaces of the wheel.

2. The brake for the bicycle of claim 1, wherein the first end portion is between the base and the third end portion, and the actuating portion and the actuated portion overlap with each other and crossly arranged.

3. The brake for the bicycle of claim 1, wherein the actuating portion has a rolling member which rotatably abuts against the actuated portion.

4. The brake for the bicycle of claim 3, wherein the actuated portion includes a guiding section and a cover portion, the rolling member rotatably abuts against the guiding section, and the cover portion is arranged on the guiding section and covers at least one part of the rolling member.

5. The brake of the bicycle of claim 4, wherein the guiding section is curved, the actuating portion includes a base and a rolling seat, the rolling seat is arranged on the base, the rolling member is rotatably arranged on the rolling seat, the base is curved, and the base is greater than the guiding section in curvature radius.

6. The brake for the bicycle of claim 1, wherein the second arm assembly further has a blocking portion, and the blocking portion optionally abuts against the first end portion.

7. The brake for the bicycle of claim 1, further including an elastic member, two ends of the elastic member respectively abutting against the base and the second arm assembly so that the second end portion and the fourth end portion having a tendency to move away from the brake surface.

8. The brake for the bicycle of claim 7, wherein the first arm assembly is pivoted to the base via a first pivot shaft; the second arm assembly is pivoted to the base via a second pivot shaft, and the second pivot shaft is disposed through the elastic member.

9. The brake for the bicycle of claim 8, wherein the base has a spacing portion, the second arm assembly abuts against the spacing portion, the elastic member is disposed around the spacing portion, the second pivot shaft is disposed through the second arm assembly and the spacing portion, and the second arm assembly swings, about the second pivot shaft, relative to the spacing portion.

10. The brake for the bicycle of claim 9, wherein the first end portion is between the base and the third end portion, the first and second arm assemblies are pivoted to the base along a first direction, and on the first direction, the actuating portion and the actuated portion are substantially in a same dimension; as viewed in the first direction, the base is c-shaped; the actuating portion has a rolling member which rotatably abuts against the actuated portion, the actuated portion includes a guiding section and a cover portion, the rolling member rotatably abuts against the guiding section, the cover portion is arranged on the guiding section and covers at least one part of the rolling member, the cover portion perpendicularly extends above the guiding section, and the guiding section is curved; the actuating portion has a base and a rolling seat, the base extends from the first end portion along the first direction, the rolling seat is disposed on a distal end of the base and protrudes laterally beyond the base, the base is curved, the base is greater than the guiding section in curvature radius, and the rolling member is rollably arranged on the rolling seat; the second arm assembly further has a blocking portion, the blocking portion optionally abuts against the first end portion, the blocking portion extends from the fourth end portion and is located between the fourth end portion and the base, and the first end portion extends across the blocking portion; the second end portion and the fourth end portion respectively have a braking member, and each said braking member is for contacting each of the two brake surfaces.
